(19) United States
(12) Patent Application Publication
(10) Pub. No.: US 2006/0172264 A1
(43) Pub. Date: Aug. 3, 2006

(54) Environment conversion system from a first format to a second format

(75) Inventors: Laurie A. Eskew, Chuluota, FL (US); John Little, Orlando, FL (US); Ryan M. Leitch, Winter Springs, FL (US)

Correspondence Address: WELSH & KATZ, LTD, 120 S RIVERSIDE PLAZA, 22ND FLOOR, CHICAGO, IL, 60606, US

(73) Assignee: Lockheed Martin Corporation

(21) Appl. No.: 11/286,641

(22) Filed: Nov. 23, 2005

Related U.S. Application Data
(60) Provisional application No. 60/631,684, filed on Nov. 30, 2004.

(51) Int. Cl. G09B 9/08

(52) U.S. Cl. 434/38

(57) ABSTRACT

A system for converting commercially available relatively inexpensive synthetic environments to formats usable with different simulation engines carries out a substantially automatic conversion process of, for example, scenery and dynamic models into a format acceptable for a predetermined simulation engine. Synchronized multi-channel displays can be presented of vehicular equipment displays, as well as forward and side views, radar images and thermal images.

### CROSS REFERENCE TO RELATED APPLICATION

This application claims the benefit of the filing date of U.S. Provisional Application Ser. No. 60/631,684 filed Nov. 30, 2004 and entitled “Environmental Conversion System from BGL to KnowBook Format with Extended Multiple Video Channels”.

### FIELD

The invention pertains to conversion systems and methods for converting scenery and model information from one graphically presentable format to a second graphically presentable format, as well as systems for visually presenting information in the second format. More particularly, the invention pertains to conversion methods for converting publicly available simulation data bases which are in a first format to a second format for presentation of a simulation, as well as presenting synchronized multi-channel information to increase the realism of the simulation.

### BACKGROUND

Simulation has proved to be an effective method for supporting crew and mission training regardless of the training domain (i.e., flight, ground, maritime, space, dismounted soldier, etc.) An integral component of the training simulation is the synthetic environment commonly known as battlespace which is the environment in which the trainee directly interacts with and what is scene in front of oneself based on the visual/site devices utilized by the trainee. Typically the generation of the synthetic environment is based on real world source data provided by National Imagery and Mapping Agency (NIMA) or the USA Geological Survey Agency.

With the emergence of high resolution gaming technology environments, the creation of numerous battlespaces based on Bruce's Graphical Language (BGL) emerged for Microsoft Simulator Based equivalent Applications. The conventional approach had been to utilize NIMA imagery, mesh and object source data to generate the battlespace but the emergence of the BGL formatted world brought a new data source to visual environment theatre.

While a specific battle-space or operation theatre may be effective for a particular training application, it should be recognized that the ability to rapidly construct a low cost high fidelity representative visualization that renders approximate real world data, is desirable and in high demand.

Additionally, there are times when a simulation requires multiple synchronized video channels to display simulated cockpit displays, out the window displays, radar displays as well as thermal or infrared displays.

Thus, in addition to an on-going need to be able to quickly and relatively inexpensively convert one type data base, in a first format, into a second format for use in different simulation engines, there is an on-going need for simultaneous multi-channel displays to be used in complex virtual training systems. Preferably the various channels will be synchronized such that out the window video for example front or either side, will be consistent with associated instrument displays, radar displays or thermal displays.

There is also a need to provide increased channels for submersion in training environment while minimizing the cost associated with additional channels to complete the field of view requirements for increased complexity of simultaneous video views in simulation and training applications.

### BRIEF DESCRIPTION OF THE DRAWING

FIG. 1 is a dioramic view of a translation, conversion and formatting process in accordance with the invention;

FIG. 2 is a diagram illustrating data translation, conversion and transformation in accordance with the process of FIG. 1;

FIG. 3 is a diagram which illustrates other aspects of a system in accordance with the invention; and

FIG. 4 is a flow diagram illustrating details of the system of FIG. 3.

### DETAILED DESCRIPTION

While embodiments of this invention can take many different forms, specific embodiments thereof are shown in the drawings and will be described herein in detail with the understanding that the present disclosure is to be considered as an exemplification of the principles of the invention, as well as the best mode of practicing same, and is not intended to limit the invention to the specific embodiment illustrated.

The present invention implements the generation of low cost gaming level quality databases for use in low to medium fidelity synthetic simulation environments. An integrated software solution is provided to streamline the usage of readily available gaming scenery components in larger scale simulation-based training environments for rapid synthetic environment generation in support of just in time training.

The present system and method translates gaming level fidelity training environments into complex simulation, sensor and weapon based synthetic environments increasing the ability to deliver just in time training to the trainee in a shortened response time while at considerably lower cost to the user.

In one aspect of the invention, a method and process are provided for decoding, transforming and translating elements of a synthetic environment to be integrated into a second, different environment, for visualization in interactive training environments. In a disclosed environment inputs can be obtained from commercially available environments. Exemplary source environments include Microsoft Flight Simulator (MSFS) 2002 and 2004.

Advantageously, the present process makes it possible to use commercially available low cost synthetic environments on entry level and mission rehearsal level training devices that range from low fidelity to high fidelity integrated systems. This method is accomplished by obtaining publicly available environments, such as the Microsoft Flight Simulator 2002 or 2004 runtime scenery files, and then converting the original data sets into portable data sets to be formatted for use in other simulation engines. This significantly reduces the cost and time to generate training environments critical to providing rapid generation cost effective environments for military training, intelligence and special operations forces absorbed in the global war effects against terrorism.

The present method and system which converts, substantially automatically from a first format, such as provided by BGL, to a second, different format provides an integrated software solution for rapid low cost conversion of commercially available off-the-shelf (COTS) scenery. individual scenery files or multiple geographic areas in addition to scenery elements and 3-dimension vehicle/platform models can be automatically converted. All converted data is preferably based on an orthographic projection relative to the World Geodetic Systems 1984 (WGS 1984) coordinate system. The converted runtime scenery is displayable using a selected commercially available simulation engine.

Source imagery and terrain files can be exported from the conversion process into other toolsets. Once ready for display, multiple display solutions are available. Additionally, the selected engine can be configured to present not just a single display output channel but a multi-channel solution without the addition of multiple processors or uniquely tailored displayed hardware. Hence, a low cost solution can be provided to distribute and assign video channel resources across multiple displays outputs.

Applications of the converted data sets could include commercial, industry, military operations, test, just in time mission readiness, special operations, mission rehearsal and distributed network exercises. A converted data set can be incorporated into school curriculums, maintenance operations, and self paced learning environments.

In one aspect of the present invention a process and a tool are provided that incorporate data elements to be combined with software procedures and processes to ingest, decode, format, store, merge, reformat, and store data sets to provide high fidelity synthetic environments, with realistic geo-typical and geo-specifically orientated features.

Embodiments of the present invention generate industry standard imagery data files for importing into COTS modeling tools to manipulate, transform and translate the data for other simulation engines targeting other simulation industry output formats.

Embodiments of the present invention implement a process for generating industry standard terrain elevation files for importing into COTS modeling tools to manipulate, transform and translate the data for other simulation engines.

Embodiments of the present invention transform a 3-D platform's runtime scenery format to one of a variety of available formats.

Embodiments of the present invention implement a process for transforming a 3-D platform's runtime scenery format to industry standard 3ds files without texture for importing into COTS modeling tools to manipulate, transform and translate the data for other simulation engines.

The Conversion Tool addresses the need for rapid dataset conversions of any geographic area to provide training while optimizing cost. Based on the training accuracy and affectivity assessments, the adaptation of the translated data set for larger integrated solutions addresses the following needs:

Accept a readily available data source based on a common format for imagery, terrain mesh, 3-d features and moving entities.

Accept local coordinate systems

Translate to WGS 84 geodetic coordinate systems

Translate to terrain tiling process

Provide ability to append multiple terrain data sets

Provide the ability to add all processed data sets into a global world

Provide the ability to selectively transform and translate only the data elements needed (imagery, mesh, discrete objects, height cues, texture, vector data, etc.)

Translation and Transformation to orthographic imagery projections.

Conversion and extraction of geo-typical 3-D scatter objects

Conversion and extraction of geo-specific 3-D objects

Transformation of data to standard image file format

Transformation and translation of elevation data to standard terrain mesh file

Translation of 3-D object reference point to a predefined common origin reference

Translation of Moving Entities exterior (i.e., airplanes, truck, cars, vehicles, etc.)

Translation of Moving Entities interior

Translation of Moving Entities gauges and consoles/dashboards

Translation of Moving Entity Sub Parts.

Advantages of embodiments of the present invention, as compared to conventional processes and methods include:

Rapid transformation and translation of COTS scenery

Rapid transformation and translation of COTS moving models

Merging of imagery, mesh, 3-D objects, and Moving models into a portable dataset

Multi-channel visualization of the datasets

Reduced development timelines

Adaptation of multiple data sources into a common data set

Increased flexibility in tools to manipulate the data sets

Integration of datasets to sensor environments

Ease of adaptation of aircraft configuration changes

Embodiments of the present invention can be applied to depict the ability to adapt to changes in industry to ingest, merge, translate, transform and format data for multiple simulation environments effectively. The rapid prototyping of training environments to support multiple training domains provides cost savings to government and industry.

A unique multiplexing plug-in application for generic simulation engines reduces the data loss and data transfer between display channels, allowing for an increase in simulation fidelity for the out the window environment and in additional vehicle platform windows (channels), instruments, and control displays. This increases the quantity of synchronized display windows provides a wide viewing area to subject the student to a higher saturation level for training emersion into a realistic interactive training session.

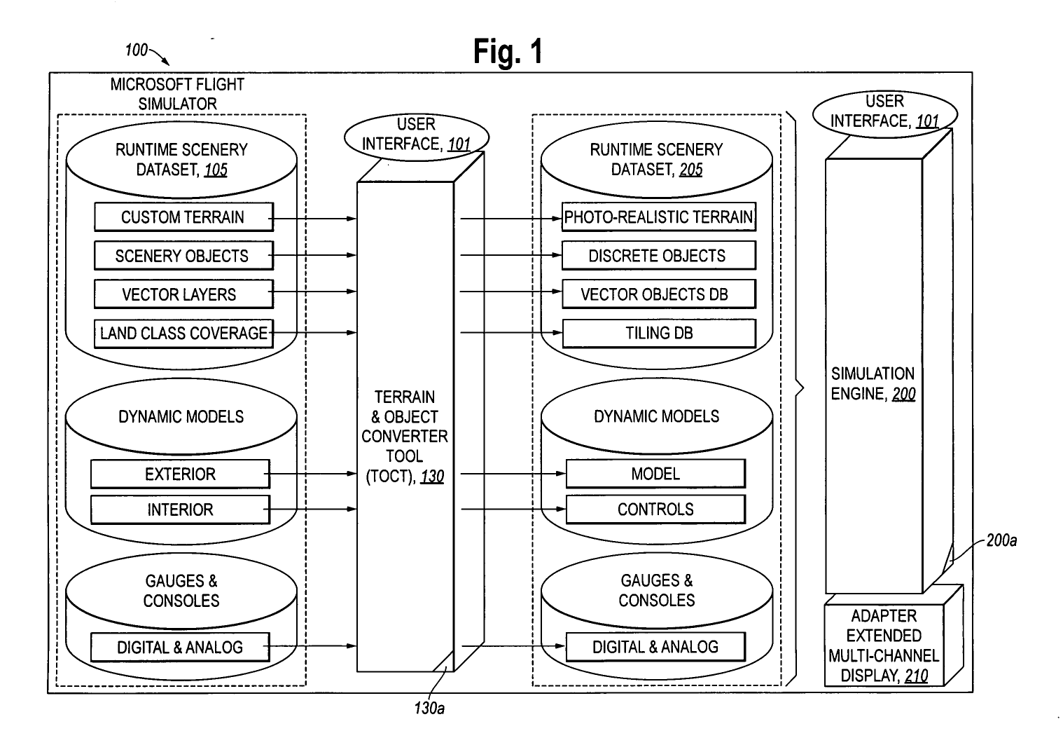

A preferred embodiment of the present invention, the system, 100, of FIG. 1, incorporates executable data and software to be combined with a processes and procedures to ingest, decode/translate, store, merge, format, and store data sets. Elements in the process include applications and data sets that run on and reside on standard Windows OS based personnel computer (PC) systems. The tool employs the use of Windows based graphic level applications, application software developers kits (SDKs) and interfaces with commercially available programs, 200.

The MSFS BGL compatible runtime scenery data, 105, on FIG. 1, can be installed from a CD-ROM or downloaded from the web as the input data set.

The Graphical User Interface (GUI), 101, on FIG. 1, permits the operator to interact with the selections of features to be ported via mouse and keyboard inputs. An embedded on-line help is available to guide the user through the process.

The Conversion Tool, 130, on FIG. 1, acts upon the user selections from GUI interface, 101, reads the BLG runtime scenery data, 105, decodes, separates, translates, transforms, compresses and formats, and stores the converted runtime scenery 205.

The converted open source runtime scenery data set, 205, on FIG. 1, can be stored at the source level or formatted for runtime for use by the visualization application associated with the simulation engine.

The compatible Graphic Runtime Application 200, on FIG. 1, loads the converted data set and performs a setup function loading the dataset for visualization and display system integration.

The Extended Multi-channel Display Adapter, 210, on FIG. 1, multiplexes the video across multiple display changes by means of software control of the video display channels and graphics pipes utilized by the Graphics Engine application.

The following paragraphs detail the data types and conversion processes to convert the MSFS runtime format to Open Source format. Developers can review the following website for additional information and available software development kits relative to MSFS: http://www.microsoft.com/games/flightsimulator/fs2004_sdk_overview.asp.

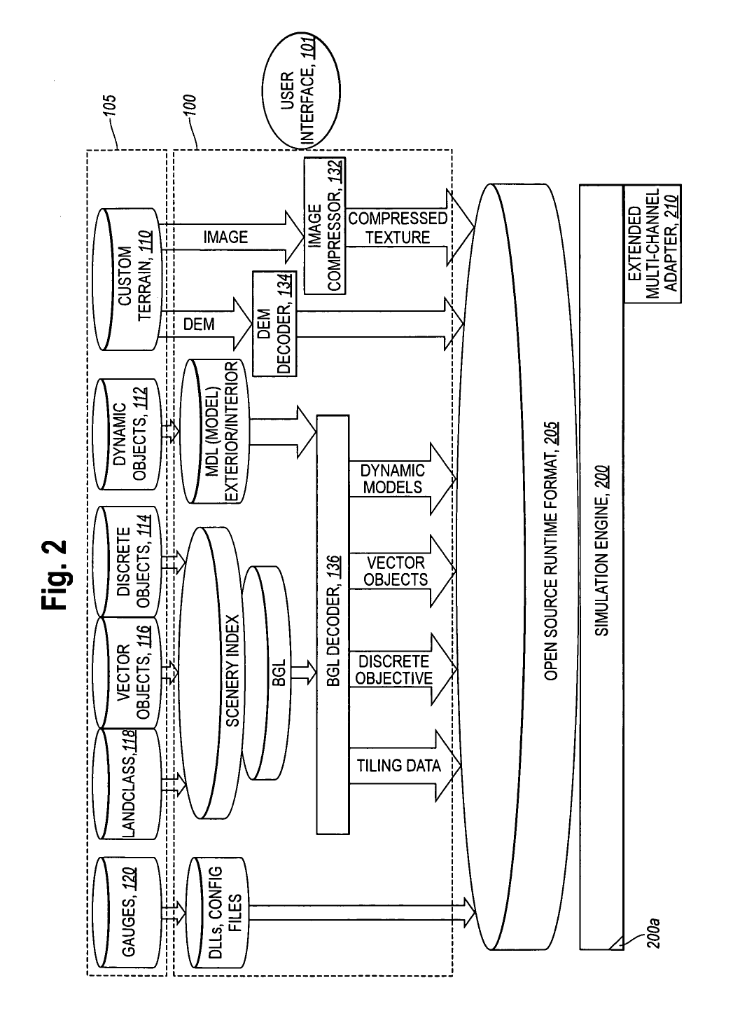

The MSFS resources contained within the BGL runtime scenery file represent a specific geographic area of coverage containing geographic scenery features, on FIG. 2: Custom Terrain, 110, autogen/discrete object, 114, vector layers, 116, and landclass objects, 118.

The MSFS BGL Custom terrain data, 110, is based on aerial photos or satellite photographic imagery and high resolution elevation grid commonly referred to as a digital elevation model (DEM). The MSFS BGL custom terrain conversion processes, 132 and 134, require analyzing MSFS custom terrain data, 110, geo-spatial model in the BGL file, reading the coding system, and extracting textures and elevation data formats to format for the open source standard.

The data set image compression process, 132, of FIG. 2, extracts imagery from custom terrain runtime scenery files for mesh and imagery to make image tiles and formats the imagery for opensource tools to enable users to manipulate, augment and format the data for runtime. The user has the option to generate image source files or formatted image files.

The Digital Elevation Mesh (DEM) decoder process, 134 extracts elevation data from custom terrain runtime scenery files, translates the data to WGS 84 and formats the elevation data set formats. The user has the option to store the data file or process them for runtime format for the graphics engine.

The MSFS dynamic objects, 112, are Model (.MDL) format files which contain exterior and interior surfaces of vehicle platforms. (i.e., airplanes, ships, trucks, cars, tanks, etc.). The BGL decoder process 136 translates the mode format files, separates the data into two datasets for exterior and interior vehicle platform models. These vehicles can be merged or maintained separately depending on the graphics engine targeted.

Converting the interior model (cockpit/console) provides an ability to integrate simulation engine parameters to drive the controls within the interior for use in other simulation formats.

The resultant model files contain the wireframe, vector, face and polygonal data related to the model sets. These wireframe files can be manipulated, modified, textured and detailed using publicly available tools such as 3D Studio Max, Polytrans, Blue Rock or other equivalent tools. The resultant model source files, 205, are available to be formatted for runtime, 200.

Associated with a dynamic objects (models) are updatable attributes for dynamic objects such as analog and digital gauges, 120. The Gauges, 120, are translated as part of the object data. However, the logic that animates the gauges is ported into a library with initial configuration settings for default conditions for inputs into cockpit and data variables are available to interact with user development platform simulations of the vehicles subsystems, 200.

The MSFS Autogen and discrete objects 114 are 3-D objects placed on the terrain. Autogen refers to geo-typically placed 3-D elements such as trees, shrubs and generic buildings while discrete objects are stadiums, statues, monuments, churches, and elements that occur in singularity.

The MSFS Vector layers, 116, are lineal features layered on terrain surfaces such as powerlines, streets, roads, rivers, canals, bridges, ship lanes, etc.

The MSFS Landclass objects, 118, are different tiles of generic geo-typical textures which represent a repetitive geographic characteristic such as farmland, urban, city, parking lots, etc.

A BGL decoder process 136, translates the autogen/discrete object data, vector (lineal) data objects and land class objects into 3-D wireframes, texture files, and terrain tiles as applicable.

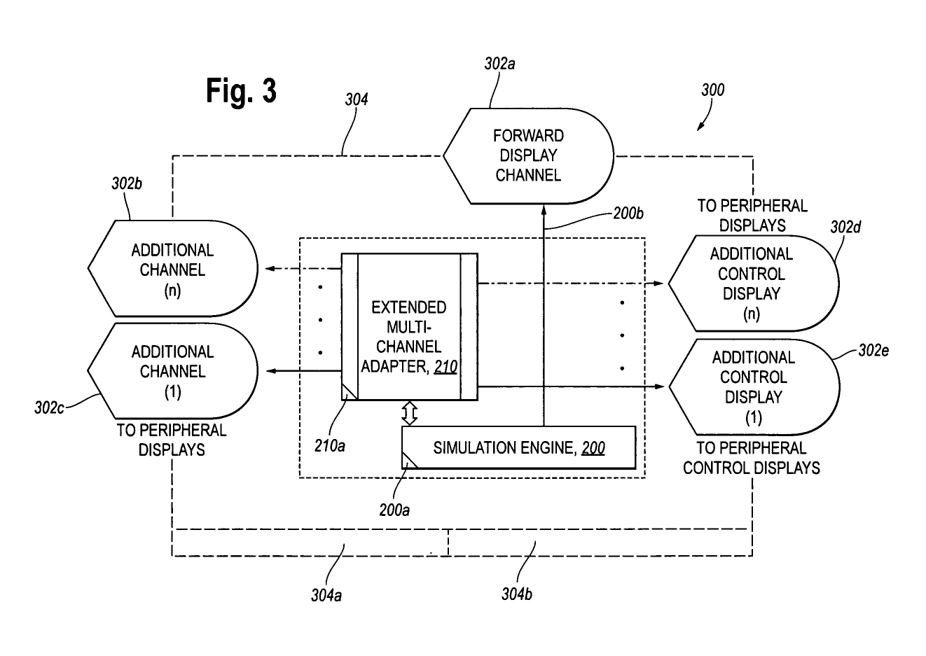

The Extended Multi-channel Display Adapter, 210, on FIG. 3, reads a configuration data settings for the display channels from a GUI, feeds the data into the multiplexing processes, assesses the graphics resolution of the system, and processing the configuration setting requested, routes the video and synchronization data to the channel, assigns the channels by purpose, and controls the visualization content via the commands send to the Graphics Engine 200 application and displays the respective data on the corresponding display peripheral.

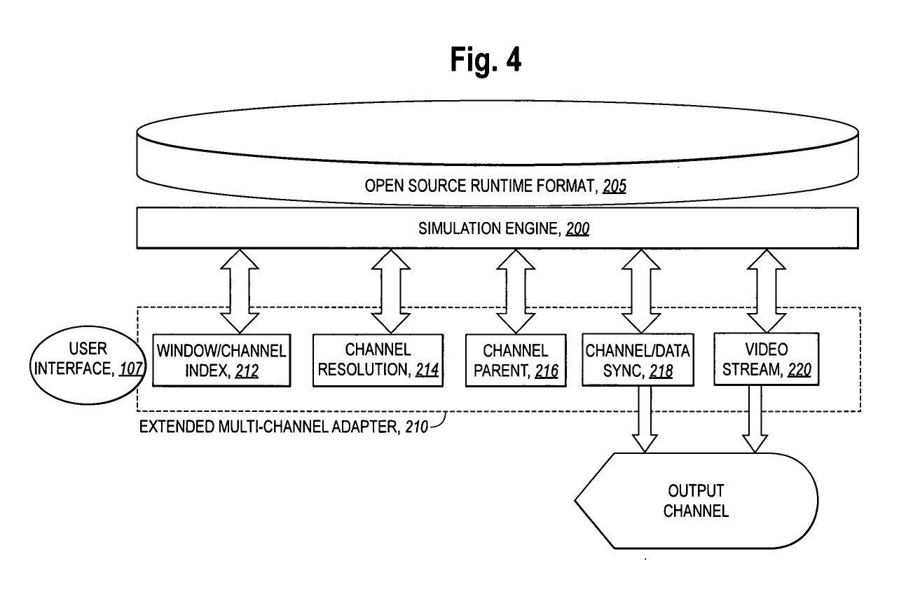

The GUI (107), FIG. 4, for the Extended Multi-channel Adapter provides the capability to capture the proposed channel configuration, allocation of available pixel resolutions across the channels, assignment of channel priorities, recording of the channel relationship to the platform vehicle being represented, and the assignment of a video output.

The window channel index process allocates the assignments from the GUI to channel(s), 212.

The channel resolution process maps pixel resolution from the graphics card to the output channel, 214.

The channel parent process identifies a priority index to the channels to enable the tethering of the display channels, 216.

The channel data sync process coordinates the update and continuity of the visualization of the data set across all the display channels/windows, 218.

The video stream process, 220, maps the video signal to the display resolution and routes the video to the display window. The picture is then rendered based on the parameters defined by the GUI.

In summation, embodiments of this invention can be used by industry to incorporate the application of this tool into data base development environments and expand the toolset to interface to other simulation specific visualization engines to enable rapid development of synthetic environments to support the warfighter. The web based availability and significant land mass coverage makes the use of the MS flight formats very useful in providing rapid cost effective environments for the military training, intelligence and special operations forces.

Those of skill in the art will understand that while the various figures have been described, at least in part, as illustrating various processes, they also illustrate conversion systems which incorporate databases, such as 105, 205, graphical users interfaces, such as interfaces 101, 107 as well as various executable software modules such as converter tool 130, simulation engine 200, adapter 210 and the various modules included therein. The respective modules are intended to be executed on or by programmable processors such as processor(s) 130a, and 200a and 210a.

It will also be understood that the multi-channel adapter 210 can be used with a simulation engine 200 which has only a single output channel. As illustrated in FIG. 3, in conjunction with a simulator 300 (such as for an aircraft, a water craft or a land vehicle) the engine 200 can provide single channel feed 200b, such as video for a forward display 302a, mounted on a simulated vehicular housing 304.

To increase the realism of the training session the adapter 210 can provide multiple display channels such as 302b,c to provide synchronized wrap-around, or side window displays. Other synchronized channels, such as 302,d,e can display control elements or gauges for the respective vehicle being simulated. These displays will be synchronized not only with the displayed outputs 302a,b,c but will also reflect the user's use of various vehicular controls such as 304a,b.

From the foregoing, it will be observed that numerous variations and modifications may be effected without departing from the spirit and scope of the invention. It is to be understood that no limitation with respect to the specific apparatus illustrated herein is intended or should be inferred. It is, of course, intended to cover by the appended claims all such modifications as fall within the scope of the claims.

1. A method of converting information from a first data base to a second data base comprising:
acquiring a first environmental data base having a first format;
substantially automatically converting environmental information in the first format to a different format.

2. A method as in claim 1 which includes prompting a user to provide at least one input to facilitate the conversion.

3. A method as in claim 1 where the first data base includes terrain information in the first format which is converted to the different format.

4. A method as in claim 1 where acquiring includes acquiring a publicly available data base.

5. A method as in claim 3 which includes converting scenery information from the first format to the different format.

6. A method as in claim 1 which includes converting at least portions of photo texture imagery, terrain elevation information, environmental models, or moving objects in the first format to the different format.

7. A method as in claim 6 which includes converting vehicular gauge information from the first format to a different format.

8. A method as in claim 3 where acquiring includes acquiring a commercially available database in the first format.

9. A method as in claim 8 which includes generating multi-channel, synchronized images based on the different format.

10. A method as in claim 5 where the first data base includes dynamic model information in a first format and the second data base receives corresponding dynamic model information in a second format.

11. A method as in claim 5 where prompting includes displaying at least portions of the environmental information in the second format.

12. A method as in claim 1 which includes converting static geographic information in the first data base to corresponding information in the second data base.

13. A method as in claim 12 which includes converting dynamic object information from a format associated with the first data base to a format associated with the second data base.

14. A method as in claim 13 which includes providing a plurality of visual prompts during the converting.

15. A simulation system comprising:
a selected data base;
first software that presents a simulation of an activity on first and second displays;
second software that provides synchronized simulation outputs for at least third and fourth displays that supplement the simulation of the activity presented on the first and second displays.

16. A system as in claim 15 where the third and fourth displays present information based on non-humanly visible electromagnetic radiation.

17. A system as in claim 16 which includes fifth and sixth displays that present video side views, and third software that presents and synchronizes the video side views with views on the first and second displays.

18. A system as in claim 17 which includes at least a programmable processor which executes the first software.

19. A system as in claim 18 which includes at least second and third processors which each execute the third software at least in part in presenting and synchronizing the video side views.

20. A system as in claim 18 which includes a simulated vehicle housing that carries the displays arranged in a predetermined configuration.

21. A system as in claim 20 which includes simulated vehicle control members carried by the housing.

22. A simulation method comprising:
generating at least one visually presentable channel of image carrying information;
generating synchronization information relative to the at least one channel;
responsive to the synchronization information, generating at least second and third channels of synchronized, displayable, image carrying information.

23. A method as in claim 22 which includes visually presenting the image carrying information of the at least one channel and the second and third channels as synchronized images.

24. A method as in claim 22 which includes providing manually manipulatable controls for a movable vehicle to be simulated, and generating channels of synchronized information in accordance with manual manipulation of the controls.

25. A method as in claim 22 where the types of information presented by the various channels are selected from a class which includes at least, human perceptible visual images, thermal images, radar-type images, radiographic-type images, ultrasonic-type images, and other non-human perceptible types of images.

26. A method as in claim 25 where one of the channels presents vehicular related displays and the other presents out-the-window-type visual displays, and including presenting one of a side window-type wrap-around display, or, vehicular related instrument displays on another channel.

27. A system comprising:
a first database;
software that automatically converts environmental information in the first data base to a second data base, the conversion including converting terrain information scenery objects, and vector-type information from the first data base to the second data base.

28. A system as in claim 27 which includes software that converts dynamic models from the first data base to the second data base.

29. A system as in claim 27 which includes software that extracts elevation information from the first database and converts it to a format for incorporation into the second data base.

30. A system comprising:
a first data base that includes a selected synthetic environment stored in a first format;
software that converts elements of the selected environment from the first format to a second format thereby substantially representing the selected environment in the second format; and
a database for storage of the converted environment.

31. A system as in claim 30 where the software carries out the converting substantially without human intervention.

32. A system as in claim 30 where the elements are selected from a class which includes at least photo-texture imagery, terrain elevation imagery, environmental models, and moving objects.
